(19) United States
(12) Patent Application Publication
(10) Pub. No.: US 2022/0248515 A1
(43) Pub. Date: Aug. 4, 2022

(54) LED DIMMING CIRCUIT, DIMMING DEVICE, AND DIMMING METHOD

(71) Applicant: SHENZHEN SENDIS SEMICONDUCTOR CO., LTD, Shenzhen (CN)

(72) Inventors: HAOMING WU, SHENZHEN (CN); QIANQIAN WANG, SHENZHEN (CN); XUNSHENG DENG, SHENZHEN (CN)

(21) Appl. No.: 17/607,339

(22) PCT Filed: Feb. 26, 2020
(86) PCT No.: PCT/CN2020/076693

§ 371 Date: Oct. 28, 2021

(30) Foreign Application Priority Data
May 24, 2019 (CN) 201910438600.9

(51) Int. Cl. H05B 45/3575; H05B 45/325

(52) U.S. Cl. CPC H05B 45/3575; H05B 45/325

(57) ABSTRACT

Disclosed are an LED dimming circuit, a dimming device and a dimming method. The LED dimming circuit comprises a reference voltage source, a line voltage compensation module, a dimming module, and a constant current source module. The line voltage compensation module outputs a compensation information to the reference voltage source according to a current line voltage, the reference voltage source modulates a reference voltage according to the compensation information, and then outputs a voltage reference having the compensation information to the dimming module, the dimming module outputs, according to the voltage reference having the compensation information and an externally input dimming signal, a dimming voltage to the constant current source module, the constant current source module controls a working current of an LED lamp string according to the dimming voltage.

### FIELD OF THE DISCLOSURE

The present disclosure relates to the technical field of LED, more particularly, to an LED dimming circuit, a dimming device, and a dimming method.

### BACKGROUND

When driving an LED lamp by a linear constant current, a fluctuation of alternating current (AC) may cause the LED lamp to flicker. Therefore, the linear dimming driving chip needs to achieve constant power to improve the overall lighting effect. However, in current dimming circuit, due to the inability to adjust the line voltage compensation coefficient, it is impossible to achieve constant power at all dimming levels, for example, when the dimming level is 100%, the constant power may be achieved by setting the line voltage compensation coefficient, when the adjustment level is 10%, the line voltage compensation coefficient remains unchanged, resulting in the line voltage compensation being too deep, which may cause the output voltage to be 0, and affects the dimming level. In addition, a single line voltage compensation coefficient may not achieve constant power at some dimming levels, which may also affect the linearity of dimming.

Therefore, the current technology needs to be improved.

### BRIEF SUMMARY OF THE DISCLOSURE

In view of the deficiency of the above mentioned prior art, an aim of the present disclosure is to provide an LED dimming circuit, a dimming device, and a dimming method, by inputting a voltage reference having a compensation information to a dimming module, so that a line voltage compensation level is correspondingly adjusted under different dimming levels in a synchronous manner, and a constant power requirement is met for various dimming levels without influencing dimming linearity, thereby improving operational stability of products.

In order to achieve the above purpose, the present disclosure adopts the following schemes:

An LED dimming circuit comprises a reference voltage source, a line voltage compensation module, a dimming module, and a constant current source module; the line voltage compensation module outputs a compensation information to the reference voltage source according to a current line voltage, the reference voltage source modulates a reference voltage according to the compensation information, and then outputs a voltage reference having the compensation information to the dimming module, the dimming module outputs, according to the voltage reference having the compensation information and an externally input dimming signal, a dimming voltage to the constant current source module, the constant current source module controls a working current of an LED lamp string according to the dimming voltage.

In the LED dimming circuit, the dimming module comprises a voltage dividing unit, a multiplex selection unit and a dimming decoding unit; the voltage dividing unit divides the reference voltage before outputting a plurality of voltage signals with corresponding amplitudes to the multiplex selection unit through different taps, the dimming decoding unit outputs a brightness data to the multiplex selection unit according to the externally input dimming signal, the multiplex selection unit outputs the voltage signal from a tap corresponding to the brightness data as a current dimming voltage to the constant current source module.

In the LED dimming circuit, the voltage dividing unit comprises a first operational amplifier and a resistor string, a non-inverting input terminal of the first operational amplifier is connected to the reference voltage source, an inverting input terminal of the first operational amplifier is connected to an output terminal of the first operational amplifier, the output terminal of the first operational amplifier is further connected to an end of the resistor string, and another end of the resistor string is grounded; the resistor string comprises a number of voltage dividing resistors connected in series, and an lower tap of each voltage dividing resistor is respectively connected to the multiplex selection unit.

In the LED dimming circuit, the multiplex selection unit comprises a plurality of switches, the voltage dividing resistors and the switches have a same number, and an end of each switch is connected to a lower tap of a corresponding voltage dividing resistor, another end of each switch is connected to the constant current source module, a control terminal of each switch is connected to the dimming decoding unit.

In the LED dimming circuit, the multiplex selection unit further comprises an encoder, an input terminal of the encoder is connected to the dimming decoding unit, a plurality of output terminals of the encoder are correspondingly connected to the control terminal of each switch.

In the LED dimming circuit, the line voltage compensation module comprises a first sampling resistor, a first MOS transistor and a second MOS transistor, an end of the first sampling resistor is connected to an input terminal of the line voltage, another end of the first sampling resistor is connected to a drain of the first MOS transistor, a gate of the first MOS transistor and the drain of the first MOS transistor are both connected to a gate of the second MOS transistor, a source of the first MOS transistor and a source of the second MOS transistor are both grounded, a drain of the second MOS transistor is connected to the reference voltage source.

In the LED dimming circuit, the constant current source module comprises a second operational amplifier, a third MOS transistor and a second sampling resistor; a non-inverting input terminal of the second operational amplifier is a control terminal of the constant current source module and is connected to the dimming module, an inverting input terminal of the second operational amplifier is connected to a source of the third MOS transistor and an end of the second sampling resistance, an output terminal of the second operational amplifier is connected to the gate of the third MOS transistor, a drain of the third MOS transistor is connected to a negative electrode of the LED lamp string; another end of the second sampling resistor is grounded.

In the LED dimming circuit, the dimming signal is one of a digital dimming signal, an analog dimming signal, and a PWM dimming signal.

An LED dimming method comprises the following steps:

outputting a compensation information to a reference voltage source by an line voltage compensation module according to a current line voltage;
modulating a reference voltage according to the compensation information by the reference voltage source and then outputting a voltage reference having the compensation information to a dimming module;
outputting a dimming voltage from the dimming module to a constant current source module according to the voltage reference having the compensation information and an externally input dimming signal;
controlling a working current of an LED lamp string by the constant current source module according to the dimming voltage.

An LED dimming device comprises a shell, a PCB is arranged in the shell, wherein the PCB is arranged with an LED dimming circuit mentioned above.

Compared with the prior art, the present disclosure provides an LED dimming circuit, a dimming device, and a dimming method. The LED dimming circuit comprises a reference voltage source, a line voltage compensation module, a dimming module, and a constant current source module; the line voltage compensation module outputs a compensation information to the reference voltage source according to a current line voltage, the reference voltage source modulates a reference voltage according to the compensation information, and then outputs a voltage reference having the compensation information to the dimming module, the dimming module outputs, according to the voltage reference having the compensation information and an externally input dimming signal, a dimming voltage to the constant current source module. The constant current source module controls a working current of an LED lamp string according to the dimming voltage. The present disclosure achieves dimming by inputting the voltage reference having the compensation information to the dimming module, so that a line voltage compensation level is correspondingly adjusted under different dimming levels in a synchronous manner, and a constant power requirement is met for various dimming levels without influencing dimming linearity, thereby improving operational stability of products.

### BRIEF DESCRIPTION OF THE DRAWINGS

FIG. 1 illustrates a frame diagram of an LED dimming circuit in the present disclosure;

FIG. 2 illustrates is a circuit diagram of the first embodiment of the LED dimming circuit in the present disclosure;

FIG. 3 illustrates a circuit diagram of the second embodiment of the LED dimming circuit in the present disclosure;

FIG. 4 illustrates a circuit diagram of a first application embodiment of the LED dimming circuit in the present disclosure;

FIG. 5 illustrates a circuit diagram of a second application embodiment of the LED dimming circuit in the present disclosure;

FIG. 6 is a flowchart of an LED dimming method for reducing harmonic distortion in the present disclosure.

### DETAILED DESCRIPTION OF EMBODIMENTS

The aim of the present disclosure is to provide an LED dimming circuit, a dimming device, and a dimming method, the present disclosure achieves dimming by inputting a voltage reference having a compensation information to a dimming module, such that a line voltage compensation level is correspondingly adjusted under different dimming levels in a synchronous manner, and a constant power requirement is met for various dimming levels without influencing dimming linearity, thereby improving operational stability of products.

In order to make the purpose, technical solution and the advantages of the present disclosure clearer and more explicit, further detailed descriptions of the present disclosure are stated hereinafter, referencing to the attached drawings and some embodiments of the present disclosure. It should be understood that the detailed embodiments of the disclosure described here are used to explain the present disclosure only, instead of limiting the present disclosure.

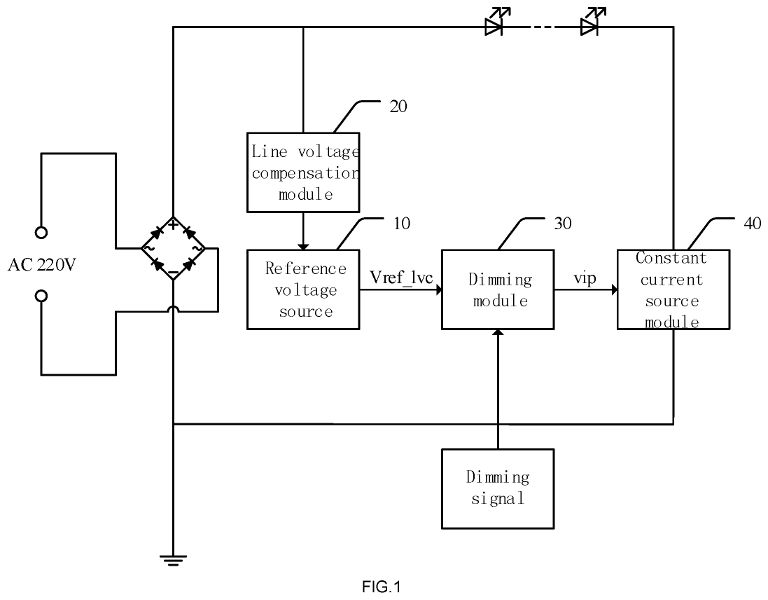

Please refer to FIG. 1, an LED dimming circuit provided by the present disclosure is connected with an LED lamp string, the LED dimming circuit comprises a rectifier bridge, a reference voltage source 10, a line voltage compensation module 20, a dimming module 30, and a constant current source module 40, an input terminal of the rectifier bridge is input with alternating current (AC), an output terminal of the rectifier bridge is connected to the line voltage compensation module 20, the line voltage compensation module 20 is connected to the dimming module 30 through the reference voltage source 10, the dimming module 30 is further connected to the constant current source module 40, the constant current source module 40 is connected to the LED lamp string.

In the present disclosure, the rectifier bridge rectifies AC and outputs a line voltage, then the line voltage compensation module 20 samples the line voltage and outputs a compensation information to the reference voltage source 10 according to a current line voltage, after the compensation information is obtained, the reference voltage source 10 modulates the reference voltage to be output according to the compensation information and then outputs voltage reference Vref_lvc having the compensation information, the voltage reference Vref_lvc is input as a new reference signal to the dimming module 30 as reference dimming voltage, when the dimming module 30 receives an externally input dimming signal, the dimming module 30 outputs a corresponding dimming voltage Vip to the constant current source module 40 according to the voltage reference Vref_lvc having the compensation information and the externally input dimming signal, the constant current source module 40 controls a working current of the LED lamp string according to the dimming voltage, that is to say, in the LED dimming circuit provided by the present disclosure, the input signal of the dimming module 30 is the voltage reference having both the compensation information and the reference voltage information. Therefore, during a dimming operation, an adjustment of the voltage reference includes an adjustment of the reference voltage and a synchronous adjustment of a line voltage compensation coefficient, that is, an unchanged line voltage compensation coefficient is no longer used at different dimming levels, so that a requirement of constant power at each dimming level may be met without affecting the dimming performance, and a stability of a product is improved without affecting the dimming level of the product.

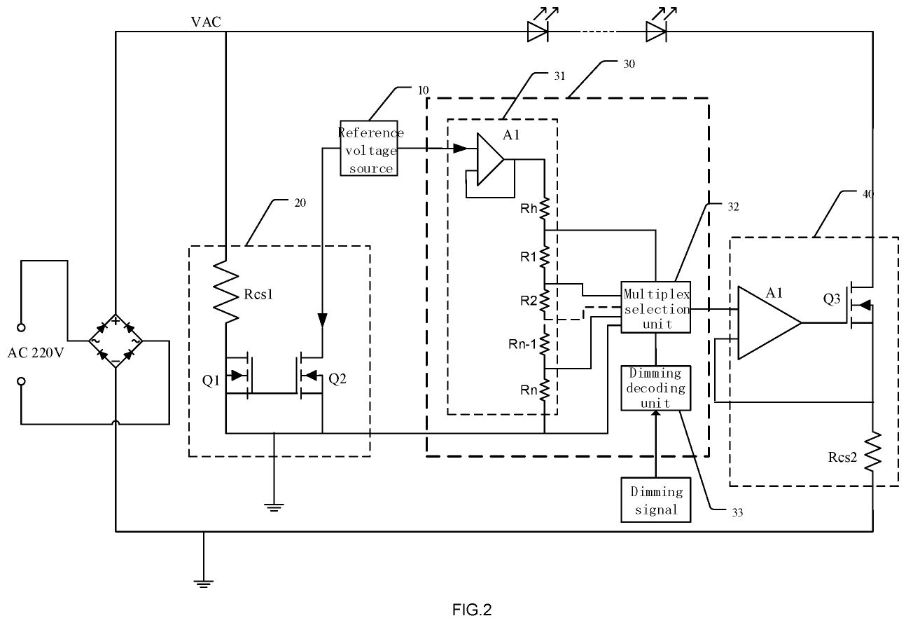

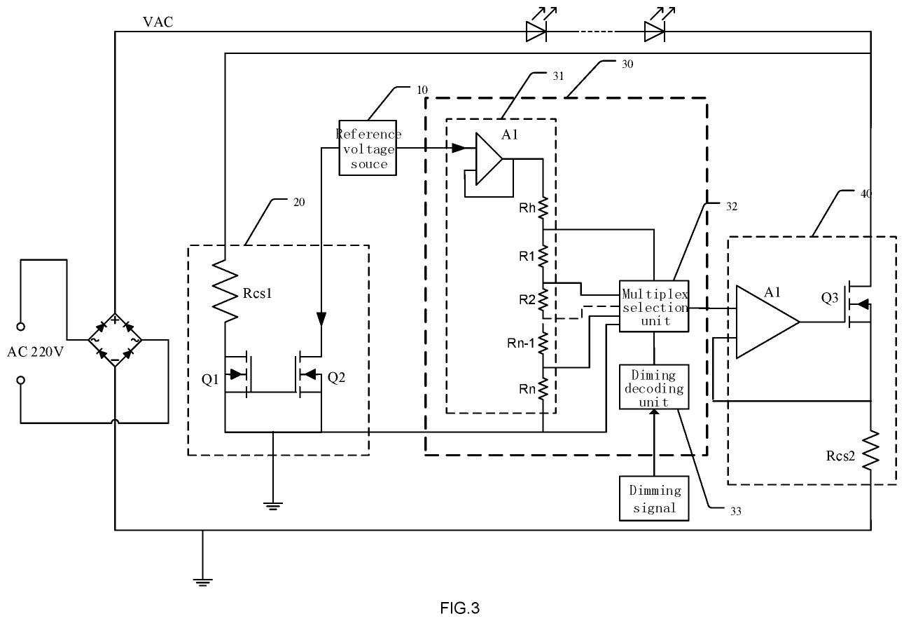

Specifically, as shown in FIG. 2 and FIG. 3, the line voltage compensation module 20 comprises a first sampling resistor Rcs1, a first MOS (Metal-Oxide-Semiconductor) transistor Q1 and a second MOS transistor Q2, an end of the first sampling resistor Rcs1 is connected to an input terminal of the line voltage, another end of the first sampling resistor Rcs1 is connected to a drain of the first MOS transistor Q1, a gate of the first MOS transistor Q1 and the drain of the first MOS transistor Q1 are both connected to a gate of the second MOS transistor Q2, a source of the first MOS transistor Q1 and a source of the second MOS transistor Q2 are both grounded, a drain of the second MOS transistor Q2 is connected to the reference voltage source 10. During an implementation, the line voltage compensation module 20 may sample from an output terminal VAC of the rectifier bridge or from an lower end of the LED lamp string, that is, as shown in FIG. 2, in first embodiment of the present disclosure, the input terminal of the line voltage is the output terminal VAC of the rectifier bridge, and the first sampling resistor Rcs1 performs line voltage sampling from the VAC. In the second embodiment of the present disclosure, as shown in FIG. 3, the input terminal of the line voltage is a negative electrode of the LED lamp string, and the first sampling resistor Rcs1 performs line voltage sampling from the negative electrode of the LED lamp string, the voltage obtained by sampling is a voltage signal being dropped by the LED light string which has a characteristics of the current line voltage, so it may also be used as a basis for subsequent compensation information output. The line voltage compensation module 20 samples the line voltage and outputs the compensation information to the reference voltage source 10, so that a signal output from the reference voltage source 10 to the dimming module 30 is the voltage reference Vref_lvc with the compensation information. When performing dimming, for example, when the dimming level is 100%, the dimming voltage output from the dimming module 30 is Vip=Vref_lvc*100%; when the dimming level is 50%, the dimming voltage output from the dimming module 30 is Vip=Vref_lvc*50%, so the voltage reference Vref_lvc contains compensation information, Vref_lvc*50% means that on the basis of halving the reference voltage Vref output from the reference voltage source 10, the degree of voltage compensation is also halved. Similarly, when the dimming level is 10%, a compensation degree of the line voltage is also adjusted to 10% synchronously, so that a requirement of constant power is met under all dimming levels without affecting the dimming performance.

Further, the dimming module 30 comprises a voltage dividing unit 31, a multiplex selection unit 32 and a dimming decoding unit 33, an input terminal of the voltage dividing unit 31 is connected to the reference voltage source 10, the voltage dividing unit 31 is connected to the multiplex selection unit 32 through different taps, the multiplex selection unit 32 is also connected to the dimming decoding unit 33 and the constant current source module 40; the voltage dividing unit 31 divides the voltage reference and outputs a plurality of voltage signals with corresponding amplitudes to the multiplex selection unit 32 through different taps, the dimming decoding unit 33 outputs brightness data to the multiplex selection unit 32 according to an externally input dimming signal, the multiplex selection unit 32 outputs the voltage signal from a tap corresponding to the brightness data as the current dimming voltage to the constant current source module 40.

That is, each tap of the voltage dividing unit 31 outputs voltage signals with different amplitudes, the dimming decoding unit 33 receives the dimming signal and outputs corresponding brightness data to the multiplex selection unit 32, the multiplex selection unit 32 selects a voltage signal of one of the taps according to the brightness data as the current dimming voltage and outputs the dimming voltage to the constant current source module 40. In the present disclosure, according to the received dimming signal, an output voltage of the voltage dividing unit 31 may be directly changed by the multiplex selection unit 32, so as to output the corresponding dimming voltage to the constant current source module 40, the constant current source module 40 adjusts a working current of the LED lamp string according to the dimming voltage to realize constant power dimming. The adjustment is simple and efficient, and no higher harmonics are introduced, which further improves the product performance.

Further, the voltage dividing unit 31 comprises a first operational amplifier A1 and a resistor string, a non-inverting input terminal of the first operational amplifier A1 is connected to the reference voltage source 10, an inverting input terminal of the first operational amplifier A1 is connected to an output terminal of the first operational amplifier A1, the output terminal of the first operational amplifier A1 is further connected to an end of the resistor string, another end of the resistor string is grounded; the resistor string includes a plurality of voltage dividing resistors connected in series, and lower taps of each voltage dividing resistor are respectively connected to the multiplex selection unit 32. In the present embodiment, the resistor string is composed of a plurality of voltage dividing resistor strings, as Rh, R1, R2, . . . , Rn−1, Rn shown in the figures, the specific number of the voltage dividing resistors may be selected according to actual dimming requirements, which is not limited in the present disclosure. An upper end of the resistor string is connected to the output terminal of the first operational amplifier A1, a lower end of the resistor string is grounded; the lower taps of each voltage dividing resistor are respectively led out and connected to the multiplex selection unit 32, that is, the present disclosure uses the first operational amplifier A1 to perform voltage following on the voltage reference having the compensation information output from the reference voltage source 10, and then divides the voltage reference by the pluralities of voltage dividing resistors, the lower taps of each voltage dividing resistor may output voltage signals with different amplitudes, the multiplex selection unit 32 controls an on and off of each tap according to the brightness data output from the dimming decoding unit 33, so as to directly change the selected dimming voltage and output the same to the constant current source module 40, thereby achieving a dimming control while adjusting a degree of compensation of the line voltage synchronously.

Specifically, the dimming signal may have a variety of options, the dimming signal may be a digital dimming signal, for example, a digital dimming signal transmitted through wired or wireless means such as SPI, I2C, UART, WiFi, and Bluetooth. Of course, a PWM dimming signal or an analog dimming signal lamp including analog voltage and analog current may also be adapted, the selection may be made according to specific product requirements. According to the difference of the dimming signals, the dimming decoding unit 33 and the multiplexer may also have a variety of implementations.

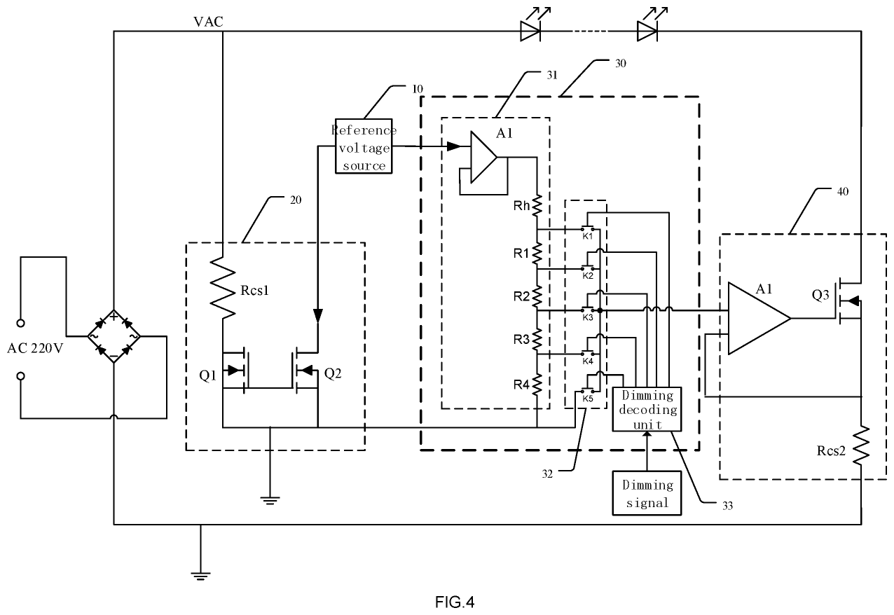

As shown in FIG. 4, in the first application embodiment of the present disclosure, the dimming signal is a digital dimming signal, the dimming decoding unit 33 may be implemented through a serial interface such as a Bluetooth module, a WiFi module, or a SPI, which is specifically used to directly receive the brightness data through wired or wireless communication and output it to the multiplex selection unit 32. In the present embodiment, the Bluetooth signal is taken as an example for description. The Bluetooth module directly receives the brightness data sent by the external Bluetooth controller, and transmits the data to the multiplex selection unit 32. It should be noted that, in the present embodiment, only 5 voltage dividing resistors are used to achieve 5-level brightness adjustment. Of course, in other embodiments, the number of the voltage dividing resistors may be adjusted as needed.

Further, the multiplex selection unit 32 in the present embodiment includes a plurality of switches corresponding to the voltage dividing resistor, as shown in K1 to K5 in FIG. 4, one end of each switch is correspondingly connected to the lower tap of a voltage divider resistor, another end of each switch is connected to the constant current source module 40, and a control terminal of each switch is connected to the dimming decoding unit. The switches may be realized by a relay, a triode, an MOSFET, a transmission gate, etc.

Further, the constant current source module 40 comprises a second operational amplifier A2, a third MOS transistor Q3 and a second sampling resistor Rcs2; a non-inverting input terminal of the second operational amplifier A2 is a control terminal of the constant current source module 40 and is connected to the dimming module 30, an inverting input terminal of the second operational amplifier A2 is connected to a source of the third MOS transistor Q3 and an end of the second sampling resistance Rcs2, the output terminal of the second operational amplifier A2 is connected to a gate of the third MOS transistor Q3, a drain of the third MOS transistor Q3 is connected to a negative electrode of the LED lamp string; another end of the second sampling resistor Rcs2 is grounded.

In an embodiment, the resistor string of the voltage dividing unit 31 divides the voltage reference to obtain five voltage signals, including V1, V2, V3, V4 and V5. The Bluetooth module directly receives the brightness data from the external Bluetooth controller, and the brightness data may be a 5-bit one-hot code, each bit controls a switch separately, for example, 00001 means K5 is turned on and other switches are turned off, at this time, the dimming voltage Vip=V5; 00010 means K4 is turned on and other switches are turned off, at this time, the dimming voltage Vip=V4; 00100 means K3 is turned on and other switches are turned off, at this time, the dimming voltage Vip=V3; other situations are derived from the same manner, the on and off of each switch may be controlled by the digital signal, so as to realize an output of different dimming voltages, which is efficient and may effectively reduce the power grid interference.

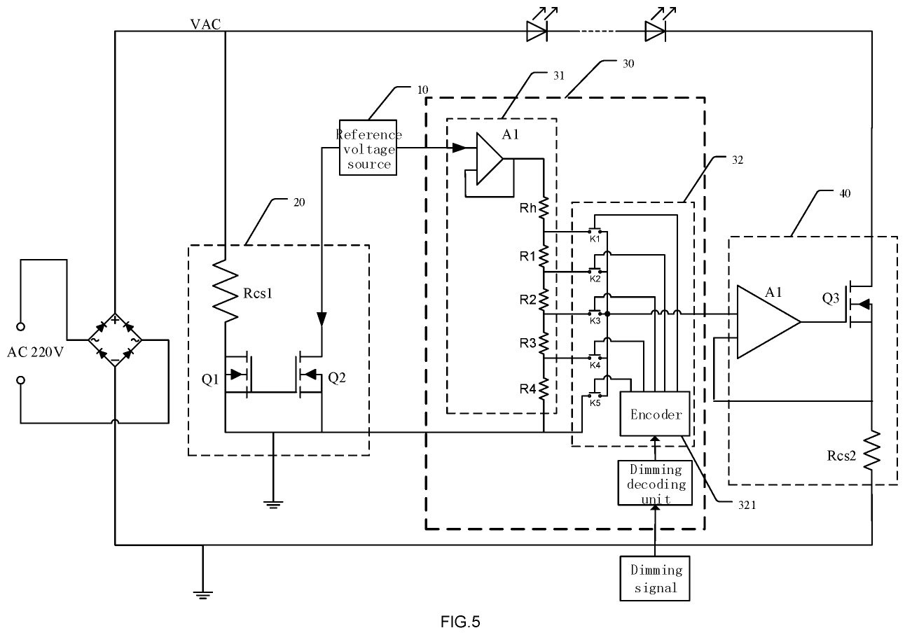

Further, please refer to FIG. 5, in the second application of the present disclosure, the multiplex selection unit 32 further includes an encoder 321, and an input terminal of the encoder 321 is connected to the dimming decoding unit 33, a plurality of output terminals of the encoder 321 are correspondingly connected to the control terminal of each switch. Different from the first application embodiment, the encoder 321 is added to the multiplex selection unit 32 in the present embodiment to realize a dimming mode of the PWM dimming signal or the analog dimming signal. For example, when an analog voltage or an analog current is adopted, the dimming decoding unit 33 may be implemented by an analog-to-digital converter (ADC), which is specifically used to perform analog-to-digital conversion on the received analog dimming signal and then output a digital signal to the encoder 321, the digital signal is encoded by the encoder 321 into encoded data adapted to the current dimming level, assuming that the ADC in the present embodiment is a 3-bit analog-to-digital conversion, and converts the analog dimming signal into 000, 001, . . . , 111 binary numbers and then transmits the same to the encoder 321, the encoder 321 may encode the received 3-bit digital signal and converted the 3-bit digital signal into a 5-bit one-hot code. Each bit controls a switch separately, one-hot encoding may be adopted. For example, encoding 000 into 00001, and encoding both 001 and 010 into 00010; encoding both 011 and 100 into 00100; encoding both 101 and 110 into 01000; encoding 111 is into 10000, so as to control a working status of each switch to realize dimming control.

When a PWM dimming signal is adapted, the dimming decoding unit 33 may be implemented by a duty cycle determiner, which is specifically used to determine the duty cycle of the received PWM signal and output the obtained duty cycle data to the encoder 321, in specific implementation, the duty cycle determiner is composed of a sampling clock and a counter. Assuming that the PWM signal is sampled N times in one cycle, the counter counts the number of times the PWM signal is sampled at a high level in one cycle, then the duty cycle of the current PWM signal may be obtained as the brightness data. After the brightness data is transmitted to the encoder 321 for coding, a coded data for controlling the on and off of each switch may be obtained, so as to realize dimming control.

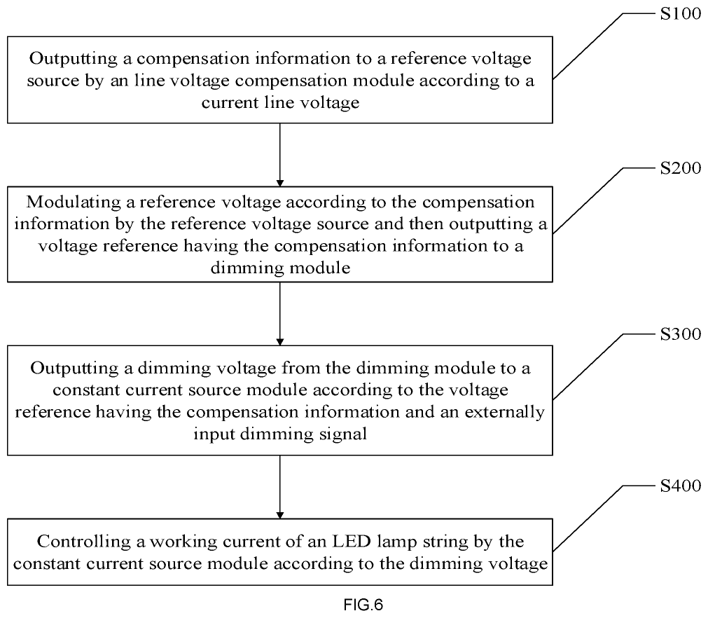

Correspondingly, the present disclosure further provides an LED dimming method. As shown in FIG. 6, the LED dimming method for reducing harmonic distortion includes the following steps:

S100, outputting a compensation information to a reference voltage source by an line voltage compensation module according to a current line voltage;
S200, modulating a reference voltage according to the compensation information by the reference voltage source and then outputting a voltage reference having the compensation information to a dimming module;
S300, outputting a dimming voltage from the dimming module to a constant current source module according to the voltage reference having the compensation information and an externally input dimming signal;
S400, controlling a working current of an LED lamp string by the constant current source module according to the dimming voltage.

The present disclosure further provides an LED dimming device which comprises a shell, a PCB is arranged in the shell, and the PCB is arranged with an LED dimming circuit as mentioned above, since the LED dimming circuit for reducing harmonic distortion is described, it would not be described in detail here.

In summary, in the LED dimming circuit, dimming device and dimming method provided by the present disclosure, the LED dimming circuit comprises a reference voltage source, a line voltage compensation module, a dimming module, and a constant current source module; the line voltage compensation module outputs a compensation information to the reference voltage source according to a current line voltage, the reference voltage source modulates a reference voltage according to the compensation information, and then outputs a voltage reference having the compensation information to the dimming module, the dimming module outputs, according to the voltage reference having the compensation information and an externally input dimming signal, a dimming voltage to the constant current source module, the constant current source module controls a working current of an LED lamp string according to the dimming voltage. The present disclosure achieves dimming by inputting the voltage reference having the compensation information to the dimming module, so that a line voltage compensation level is correspondingly adjusted under different dimming levels in a synchronous manner, a constant power requirement is met for various dimming levels without influencing dimming linearity, thereby improving operational stability of products.

It should be understood that, the application of the present disclosure is not limited to the above listed embodiments. Those skilled in the art can improve or change the applications according to the above descriptions, all of these improvements and transforms should belong to the scope of protection in the appended claims of the present disclosure.

1. An LED dimming circuit, comprising:
a reference voltage source, a line voltage compensation module, a dimming module, and a constant current source module;
wherein the line voltage compensation module outputs a compensation information to the reference voltage source according to a current line voltage, the reference voltage source modulates a reference voltage according to the compensation information, and then outputs a voltage reference having the compensation information to the dimming module, the dimming module outputs, according to the voltage reference having the compensation information and an externally input dimming signal, a dimming voltage to the constant current source module, the constant current source module controls a working current of an LED lamp string according to the dimming voltage.

2. The LED dimming circuit according to claim 1, wherein the dimming module comprises a voltage dividing unit, a multiplex selection unit and a dimming decoding unit, wherein the voltage dividing unit divides the reference voltage before outputting a plurality of voltage signals with corresponding amplitudes to the multiplex selection unit through different taps, the dimming decoding unit outputs a brightness data to the multiplex selection unit according to the externally input dimming signal, and the multiplex selection unit outputs the voltage signal from a tap corresponding to the brightness data as a current dimming voltage to the constant current source module.

3. The LED dimming circuit of claim 2, wherein the voltage dividing unit comprises a first operational amplifier and a resistor string, wherein a non-inverting input terminal of the first operational amplifier is connected to the reference voltage source, an inverting input terminal of the first operational amplifier is connected to an output terminal of the first operational amplifier, wherein the output terminal of the first operational amplifier is further connected to an end of the resistor string, and another end of the resistor string is grounded, wherein the resistor string comprises a number of voltage dividing resistors connected in series, and a lower tap of each voltage dividing resistor is respectively connected to the multiplex selection unit.

4. The LED dimming circuit according to claim 3, wherein the multiplex selection unit comprises a plurality of switches, wherein the voltage dividing resistors and the switches have a same number, and an end of each switch is connected to a lower tap of a corresponding voltage dividing resistor, another end of each switch is connected to the constant current source module, a control terminal of each switch is connected to the dimming decoding unit.

5. The LED dimming circuit according to claim 4, wherein the multiplex selection unit further comprises an encoder, wherein an input terminal of the encoder is connected to the dimming decoding unit, a plurality of output terminals of the encoder are correspondingly connected to the control terminal of each switch.

6. The LED dimming circuit of claim 1, wherein the line voltage compensation module comprises a first sampling resistor, a first MOS transistor and a second MOS transistor, wherein an end of the first sampling resistor is connected to an input terminal of the line voltage, another end of the first sampling resistor is connected to a drain of the first MOS transistor, a gate of the first MOS transistor and the drain of the first MOS transistor are both connected to a gate of the second MOS transistor, a source of the first MOS transistor and a source of the second MOS transistor are both grounded, a drain of the second MOS transistor is connected to the reference voltage source.

7. The LED dimming circuit according to claim 1, wherein the constant current source module comprises a second operational amplifier, a third MOS transistor and a second sampling resistor, wherein a non-inverting input terminal of the second operational amplifier is a control terminal of the constant current source module and is connected to the dimming module, an inverting input terminal of the second operational amplifier is connected to a source of the third MOS transistor and an end of the second sampling resistance, an output terminal of the second operational amplifier is connected to the gate of the third MOS transistor, a drain of the third MOS transistor is connected to a negative electrode of the LED lamp string; another end of the second sampling resistor is grounded.

8. The LED dimming circuit according to claim 1, wherein the dimming signal is one of a digital dimming signal, an analog dimming signal, and a PWM dimming signal.

9. An LED dimming method, wherein comprising steps of:
outputting a compensation information to a reference voltage source by an line voltage compensation module according to a current line voltage;
modulating a reference voltage according to the compensation information by the reference voltage source and then outputting a voltage reference having the compensation information to a dimming module;
outputting a dimming voltage from the dimming module to a constant current source module according to the voltage reference having the compensation information and an externally input dimming signal; and
controlling a working current of an LED lamp string by the constant current source module according to the dimming voltage.

10. An LED dimming device comprising a shell, a PCB is arranged in the shell, wherein the PCB is arranged with an LED dimming circuit according to claim 1.
